(19) United States
(12) Patent Application Publication
(10) Pub. No.: US 2010/0106806 A1
(43) Pub. Date: Apr. 29, 2010

(54) SYSTEM AND METHOD FOR LOCATION-BASED SERVICE ACCOUNTING

(75) Inventors: Yong Xie, Shenzhen (CN); Wei Zhang, Shenzhen (CN); Hong Li, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/651,107

(22) Filed: Dec. 31, 2009

Related U.S. Application Data
(63) Continuation of application No. PCT/CN2008/072004, filed on Aug. 15, 2008.

(30) Foreign Application Priority Data
Aug. 16, 2007 (CN) 200710146769.4

(51) Int. Cl. G06F 15/16

(52) U.S. Cl. 709/219

(57) ABSTRACT

A system and a method for implementing LBS accounting are disclosed. The system includes a LS and an accounting server in a CSN. The LS includes an LS CF, which is adapted to collect LBS-related accounting information with respect to the user who sends the location request and/or the user to be located at different time points, create UDRs of the LS according to the accounting information, and send the UDRs of the LS to the accounting server. The accounting server performs accounting for the LBS according to the received UDRs.

### CROSS-REFERENCE TO RELATED APPLICATIONS

This application is a continuation of International Application No. PCT/CN2008/072004, filed on Aug. 15, 2008, which claims priority to Chinese Patent Application No. 200710146769.4, filed on Aug. 16, 2007, both of which are hereby incorporated by reference in their entireties.

### FIELD OF THE INVENTION

The present invention relates to communication technologies, and in particular, to a system and a method of accounting for a Location Based Service (LBS).

### BACKGROUND

Currently, with the increase of people's requirements for location-based information services, the wireless positioning technology attracts attention of more and more researchers. The Global Positioning System (GPS) is a great advancement of the wireless positioning technology. The positioning precision of the GPS is as precise as less than 10 m. Although the GPS accomplishing an ideal positioning effect, it requires a special receiving device, which brings inconvenience to most users. In recent years, with popularization of the cellular mobile system, the positioning system is applied to cellular system design, handover, service area determining, and traffic monitoring.

With the development of the mobile communication industry, new mobile Value Added Services (VASs) and mobile data services become strong economic growth points of the mobile communication market. Operators require diversified services to improve competitiveness more and more urgently. The Location Services (LCS) is a very promising mobile VAS, and is bound to grow rapidly.

The Location Based Service (LBS) is also known as a mobile location service, and means that the mobile network obtains the geographic location information (longitude and latitude) of a Mobile Station (MS) through a specific positioning technology, provides the location information for the mobile user, communication system or a third party, and provides the mobile user with call services and non-call services related to the user's location under support of electronic map information.

In different network system, the positioning systems may vary in architecture. Generally, a positioning system includes: a location client, a Location Server (LS), and a Location Controller (LC). The position information requester such as a location client or MS sends a request for positioning a target MS to the LS, requesting to obtain the information about the location of the target MS. The LS makes a response and handles the location request of the client or MS, and sends the location request to a proper access network. The LC is generally located in the access network part, and is responsible for measuring the location of the target MS. After completion of the location measurement, the LC returns the location result to the LS. The LS may convert the format of the location result, and forward the final result to the location information requester.

The Worldwide Interoperability for Microwave Access (WiMAX) is a wireless Metropolitan Area Network (MAN) technology. In the existing WiMAX system, the accounting is based on an IP session or packet data streams, and begins upon completion of setting up an IP session and continues until release or completion of the IP session. In an accounting process, the network needs to collect the information such as IP stream traffic and time in real time. However, the LBS is different from general WiMAX services such as voice service and video service. The user of the LBS cares about only the final location result, and the positioning process involves signaling interaction rather than IP data packet transmission. Therefore, the existing WiMAX accounting system is unable to fulfill the LBS accounting requirements.

### SUMMARY

The embodiments of the present invention provide an LBS accounting system and an LBS accounting method to implement accounting for the LBS in a WiMAX network in light of the LBS characteristics.

The technical solution put forward in the embodiments of the present invention is elaborated as follows.

The LBS accounting system includes an LS located in a Connect Service Network (CSN) and an accounting server.

The LS includes an LS Accounting Function (CF), which is adapted to collect LBS-related accounting information with respect to the user who sends the location request and/or the user to be located at different time points, create Usage Data Records (UDRs) of the LS according to the accounting information, and send the UDRs of the LS to the accounting server.

The accounting server performs accounting for the LBS according to the received UDRs.

The LBS accounting method includes:

collecting, by a CSN in the LBS process, LBS-related accounting information at different time points, and generating UDRs of a LS according to the accounting information; and

performing accounting for the LBS according to the UDRs of the LS.

Therefore, considering that the LBS is different from ordinary services (such as voice service and video service), the embodiments of the present invention performs accounting based on events, thus implementing accounting in different positioning scenarios.

### BRIEF DESCRIPTION OF THE DRAWINGS

FIG. 1 shows a structure of an LBS accounting system in an embodiment of the present invention;

FIG. 2 shows an LBS offline accounting process in an MO-LR mode in a non-roaming scenario in the method in an embodiment of the present invention;

FIG. 3 shows an LBS offline accounting process in an MO-LR mode in a roaming scenario in the method in an embodiment of the present invention;

FIG. 4 shows an LBS offline accounting process in an MT-LR mode in a non-roaming scenario in the method in an embodiment of the present invention;

FIG. 5 shows an LBS offline accounting process in an NI-LR mode in the method in an embodiment of the present invention;

FIG. 6 shows an LBS online accounting process in an MO-LR mode in a non-roaming scenario in the method in an embodiment of the present invention; and

FIG. 7 shows an LBS online accounting process in an MT-LR mode in a roaming scenario in the method in an embodiment of the present invention.

### DETAILED DESCRIPTION

In order to make the technical solution under the present invention clearer to those skilled in the art, the following describes the embodiments of the present invention in more detail with reference to accompanying drawings.

Considering that the LBS is different from ordinary services (such as voice service and video service), the embodiments of the present invention performs accounting based on events, thus implementing accounting in different positioning scenarios.

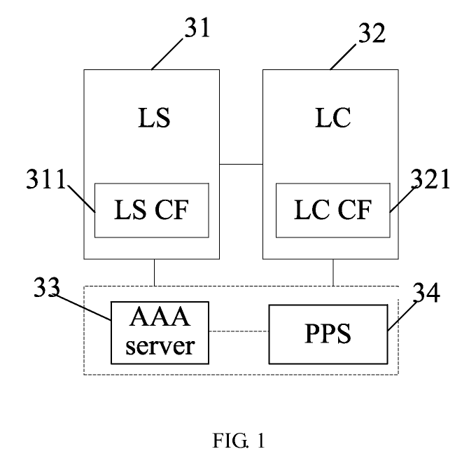

FIG. 1 shows a structure of an accounting system in an embodiment of the present invention.

This system includes an LS 31, an LC 32, and an accounting server. The accounting server may be an Authentication Authorization Accounting (AAA) server 33 in FIG. 1, or an online accounting server (which is also known as a Pre-Paid Server (PPS)) 34 in FIG. 1, or both an AAA server 33 and a PPS 34. The LS 31 includes an LS Accounting Function (LS CF) 311. The LC 32 includes an LC Accounting Function (LC CF) 321.

The entities in the system are described below.

The LS may be located in the CSN, and is an external interface of the network. The LS receives and handles location requests, and forwards legal location requests to a proper LC to position the target. The location request carries the parameters such as LCS client identity, identity of the target MS to be located, and Quality of Service (QoS) requirement for the location result. The LS 31 may exist independently in the CSN.

The LC may be located in an Access Service Network (ASN), and is a processing and control center of the positioning function in the ASN. The LC receives a location request from the LS 31, positions the target MS, and calculates and returns a location result. The LC may be a functional unit. In this case, the LC may be located in an ASN Gateway (ASN GW), or exist independently.

The LS CF executes the location accounting function of the LS, collects the LBS-related accounting information with respect to the client that sends the location request and the target MS to be located, and creates Usage Data Records (UDRs) and sends the UDRs to the AAA server. For online accounting users, the LS CF applies to the PPS for a quota before the LS sends a location request to the access network. Upon completion of positioning, if the QoS level of the actual location result is lower than the QoS level requested by the user, which leads to a balance of the allocated quota, the LS CF needs to request the PPS to return the balance.

The LC CF detects the location message at the ASN part, collects the location accounting information, creates UDRs, and sends the UDRs to the AAA server of the ASN. The UDRs is a basis for accounting the LS when providing location data measurement services for the LS. It is also possible that LS located in the ASN does not perform independent collection of the location accounting information, depending on the subscription relation between the ASN operator and the CSN operator. For example, if the ASN and the CSN belong to the same operator, the ASN does not need to perform independent collection of the location accounting information.

The AAA server includes an offline accounting system of the WiMAX network.

As an online accounting system of the WiMAX network, the PPS allocates and manages the user's session quota for general session services; for the LBS, the PPS needs to respond to the location quota request and allocate a location quota. The quota indicates whether the LBS requested by the user is accepted.

In the system in this embodiment, LS accounting is independent of the access network accounting. The UDRs created by the LS CF on the LS and the UDRs created by the LC CF on the LC may be transmitted to the same accounting server or different accounting servers.

The accounting record generated on the LC CF of the ASN needs to be sent to the AAA server corresponding to the ASN, and the accounting record generated by the LS CF on the LS may be sent to the AAA server or another accounting system except the AAA server.

The system in this embodiment implements LBS accounting in the WiMAX network. The accounting may include the accounting for the MS which requests the location information, and may further include the accounting for the target MS to be located. The accounting for the target MS to be located may be given up, depending on the accounting policy of the operator. Moreover, the system in this embodiment implements both offline accounting and online accounting: If the MS that requests the location information and the target MS to be located are two different entities, and both of them need to be charged, the accounting mode may vary between them. That is, one employs the offline accounting mode and the other employs the online accounting mode.

If the user that requests the location information is an online accounting user, the LS CF needs to apply to the PPS for a quota before the LS sends a location request to the access network. When the PPS receives a quota request from the LS CF, the PPS needs to allocate a quota to the user according to the QoS required by the service requested by the user, LBS subscription information of the user, and account balance of the user. The quota indicates whether the LBS requested by the user is accepted. The LS proceeds with further positioning operations after the LS CF obtains the quota. If a balance of the allocated quota is left after completion of the positioning, the LS CF requests the PPS to return the quota balance of the user.

The system in this embodiment may correlate the LBS accounting with the location precision and time responsivity of the location result. For example, the QoS levels of the location result are differentiated in light of the parameters such as location precision and time responsivity so that the quota of the location accounting is correlated with the QoS level of the location result, namely, higher QoS levels correspond to higher accounting quotas. In the positioning process, the LS CF and the LC CF record the QoS level requested by the user and the location result QoS level finally measured by the network. If the actual location result QoS level is lower than the QoS level requested by the user, the user may be accounted according to the QoS level of the actual location result, or may be not accounted, depending on whether the location request indicates permission of degrading the QoS level in the case that the requested QoS level of the location result is not fulfilled. In this case, for online accounting users, the quota balance of the user needs to be returned; otherwise, the user is charged according to the QoS level requested by the user.

Generally, depending on the sender of the location request, the positioning process comes in three types:

Mobile Originated Location Request (MO-LR): The MS sends a location request, namely, the MS requests to obtain its own geographic location information, or sends its location information to another LCS client.

Mobile Terminated Location Request (MT-LR): An LCS client sends the location request, requesting the location of a target MS.

Network Induced Location Request (NI-LR): The network sends the location request. This mode is generally applicable to emergent positioning of a MS in an emergent LBS.

An LBS accounting method is provided in an embodiment of the present invention. The method can implement offline accounting and online accounting for an LBS. With respect to the three positioning processes above, the LBS offline accounting process and the LBS online accounting process in the method provided in this embodiment are described below.

### I. Offline Accounting

In the MO-LR positioning process in a non-roaming scenario, the LS CF collects the accounting information about the LBS initiated by the Mobile Station (MS), and creates UDRs. The LC on the ASN GW detects the LBS in the ASN, collects the accounting information through the LC CF, and creates UDRs. The LS and the LC send the UDRs to the AAA server, or to other accounting servers except the AAA server. In this way, the LS (or its provider) and the ASN (or its operator) accomplish independent offline accounting for the LBS.

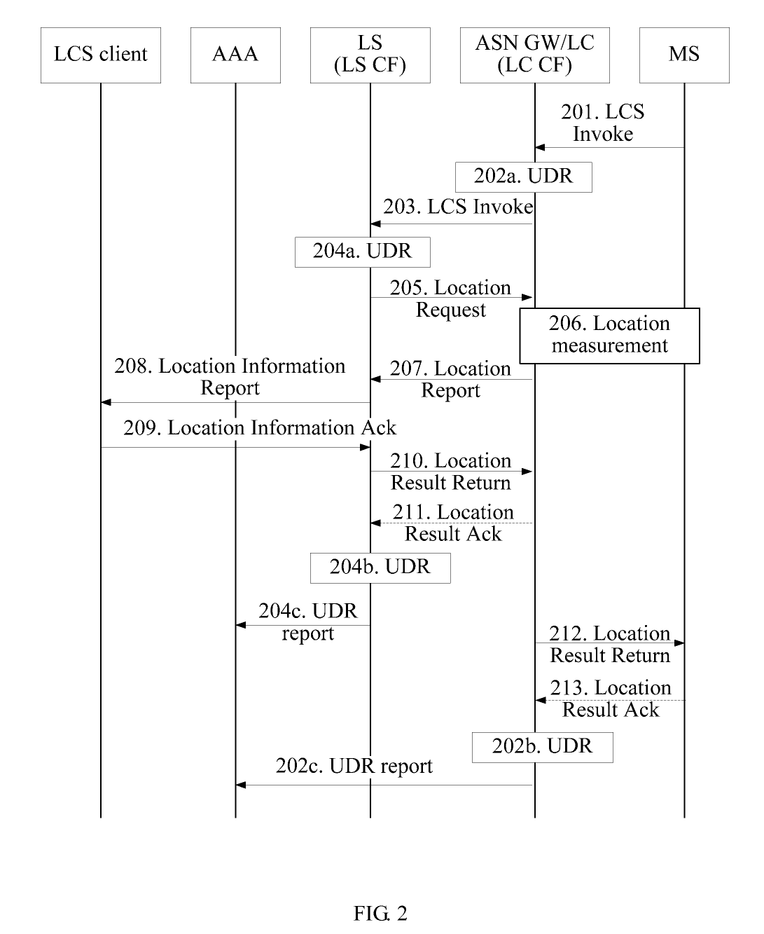

FIG. 2 shows an LBS offline accounting process in an MO-LR mode in a non-roaming scenario in the method in an embodiment of the present invention. The accounting process includes:

Step 201: The MS sends an LCS Invoke message to the LC, requesting to position the MS itself.

Step 202a: The LC CF on the LC initiates creation of UDRs. The LC CF begins to collect accounting information and create UDRs. This UDR includes but is not limited to: an identity of the location request oridentity, an identity of the LCS client or another entity for receiving the location result, location type, time of initiating the location request, time of creating the UDR, QoS parameter (such as location precision, response time, requested QoS level) of the requested LBS, and periodical location information (such as frequency, count, or total duration), where the time of creating the UDR and the periodical location information are optional.

Step 203: The LC forwards the LCS Invoke to the selected LS.

Step 204a: The LS processes the location request, for example, checks the user subscription information. The LS CF located on the LS begins to collect accounting information and create UDRs. This UDRs includes but is not limited to: an identity of the location request oridentity, an identity of the LCS client or another entity for receiving the location result, location type, time of initiating the location request, time of creating the UDR, QoS parameter (such as location precision, response time, requested QoS level) of the requested LBS, and periodical location information (such as frequency, count, or total duration), where the time of creating the UDR and the periodical location information are optional.

Step 205: The LS sends a location request to the LC according to the QoS information in the location request.

Step 206: The LC determines the location method and the data required for the location according to the QoS in the location request, interacts with the MS, and finishes data measurement required for the location.

Step 207: The LC calculates the location result according to the location measurement data, sends a location report to the LS, and reports the location calculation result to the LS.

Step 208: The LS sends the location result information to the LCS client.

Step 209: After receiving the location result information, the LCS client returns a Location Information Ack message, indicating successful receiving of the location result.

Step 210: Through a location result return message, the LS sends the location result to the LC.

Step 211: After receiving the location result return message from the LS, the LC sends a location result ack message to the LS, indicating successful receiving of the location result. This step is omissible.

Step 204b: This step corresponds to step 204a. The LS CF finishes collecting the accounting information in the LS, and may create new UDRs correlated with the UDR in step 204a, or add a new UDR entry into the UDRs created in step 204a. The UDR includes but is not limited to: final location result data, actually applied location method, and QoS parameter of the location result.

Step 204c: The LS CF reports the UDRs to the AAA server.

Step 212: Through a location result return message, the LC sends the final location result to the MS.

Step 213: The MS returns a location result ack message, indicating successful receiving of the location result. Because this step makes it possible for the user to escape accounting through rejection of sending the ack message after receiving of the location result, this step is omissible.

Step 202b: This step corresponds to step 202a. The LC CF finishes collecting the location accounting information in the LC, and may create new UDRs correlated with the UDR in step 202a, or add a new UDR entry into the UDRs generated in step 202a. The UDR includes but is not limited to: final location result data, actually applied location method, and QoS level of the location result.

Step 202c: The LC CF reports the UDRs to the AAA server.

If the MS indicates the periodical location requirements and information in the location request, steps 205-213 need to be repeated according to the periodical location count or total duration indicated in the periodical location information. The UDR created in the LS and LC may be sent to the accounting server uniformly after completion of all required periodical location, or sent to the accounting server at set intervals.

In the MO-LR positioning process in a roaming scenario, the CF on a Home-LS (H-LS) and a Visited-LS (V-LS) and the CF on a Visited-LC (V-LC) need to collect the accounting information respectively and create independent accounting records.

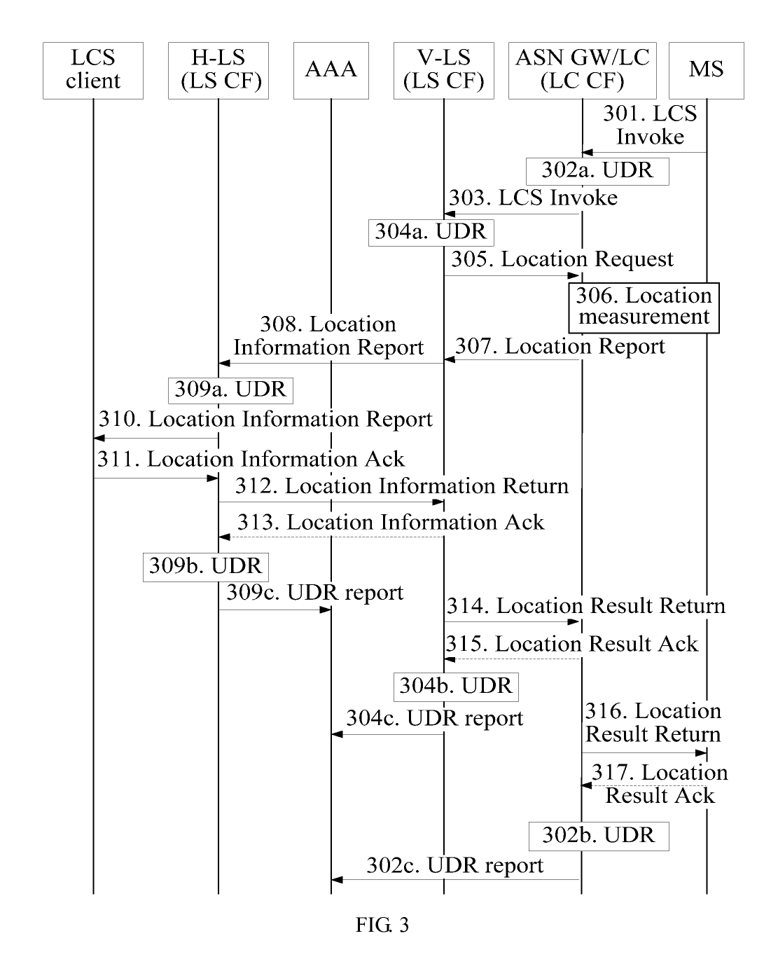

FIG. 3 shows an LBS offline accounting process in an MO-LR mode in a roaming scenario in the method in an embodiment of the present invention. As shown in FIG. 3, the accounting process is similar to that in the non-roaming scenario, and is briefly described below:

Step 301: The MS sends a location request to the LC, requesting to locate itself.

Step 302a: The LC CF initiates creation of UDRs, collects accounting information, and creates a UDR entry.

Step 303: The LC forwards the location request to the V-LS.

Step 304a: The V-LS handles the location request, for example, checks the user subscription information. This process may involve interaction between the V-LS and the H-LS. The LS CF located on the V-LS begins to collect the accounting information and create UDRs.

Step 305: The V-LS sends a location request to the LC.

Step 306: The LC determines the location method and the data required for the location according to the QoS in the location request, interacts with the MS, and finishes data measurement required for the location.

Step 307: The LC calculates the location result according to the location measurement data, sends a location report to the V-LS, and reports the location calculation result to the V-LS.

Step 308: The V-LS sends the location result information to the H-LS.

Step 309a: The H-LS handles the location request, for example, checks the user subscription information. The CF located on the H-LS begins to collect the accounting information and create UDRs.

Step 310: Through a Location Information Report, the H-LS sends the location result information to the LCS client.

Step 311: After receiving the location result information, the LCS client returns a Location Information Ack message, indicating successful receiving of the location result.

Step 312: After receiving the Location Information Ack message from the LCS client, the H-LS sends the location result to the V-LS through a Location Result Return message.

Step 313: After receiving the Location Result Return message from the H-LS, the V-LS sends a Location Result Ack message to the H-LS, indicating successful receiving of the location result. This step is omissible.

Step 309b: This step corresponds to step 309a. The CF located on the H-LS finishes collecting the accounting information in the LS, and may create a new UDR correlated with the UDRs in step 309a, or add a new UDR entry into the UDRs generated in step 309a. The UDR includes but is not limited to: final location result data, actually applied location method, and QoS parameter of the location result.

Step 309c: The CF located on the H-LS reports the created UDRs to the AAA server.

Step 314: Through a Location Result Return message, the V-LS sends the location result to the LC.

Step 315: After receiving the Location Result Return message from the V-LS, the LC sends a Location Result Ack message to the V-LS, indicating successful receiving of the location result. This step is omissible.

Step 304b: This step corresponds to step 304a. The CF located on the V-LS finishes collecting the accounting information in the V-LS, and may create a new UDR correlated with the UDRs in step 304a, or add a new UDR entry into the UDRs generated in step 304a. The UDR includes but is not limited to: final location result data, actually applied location method, and QoS parameter of the location result.

Step 304c: The CF located on the V-LS reports the created UDRs to the AAA server.

Step 316: Through a Location Result Return message, the LC sends the final location result to the MS.

Step 317: The MS returns a Location Result Ack message, indicating successful receiving of the location result. Because this step makes it possible for the user to escape accounting through rejection of sending the Ack message after receiving of the location result, this step is omissible.

Step 302b: This step corresponds to step 302a. The LC CF located on the LC finishes collecting the location accounting information in the LC, and may create a new UDR correlated with the UDRs in step 302a, or add a new UDR entry into the UDRs generated in step 302a. The UDR includes but is not limited to: final location result data, actually applied location method, and QoS parameter of the location result.

Step 302c: The LC CF reports the created UDRs to the AAA server.

In the MT-LR positioning process in a non-roaming scenario, the LS CF collects the accounting information about the LBS initiated by the LCS client, and creates UDRs. The LC on the ASN GW detects the LBS in the ASN, collects the accounting information through the LC CF, and creates UDRs. The LS and the LC send the created UDRs to the AAA server, or to other accounting servers except the AAA server. In this way, the LS (or its provider) and the ASN (or its operator) accomplish independent offline accounting for the LBS.

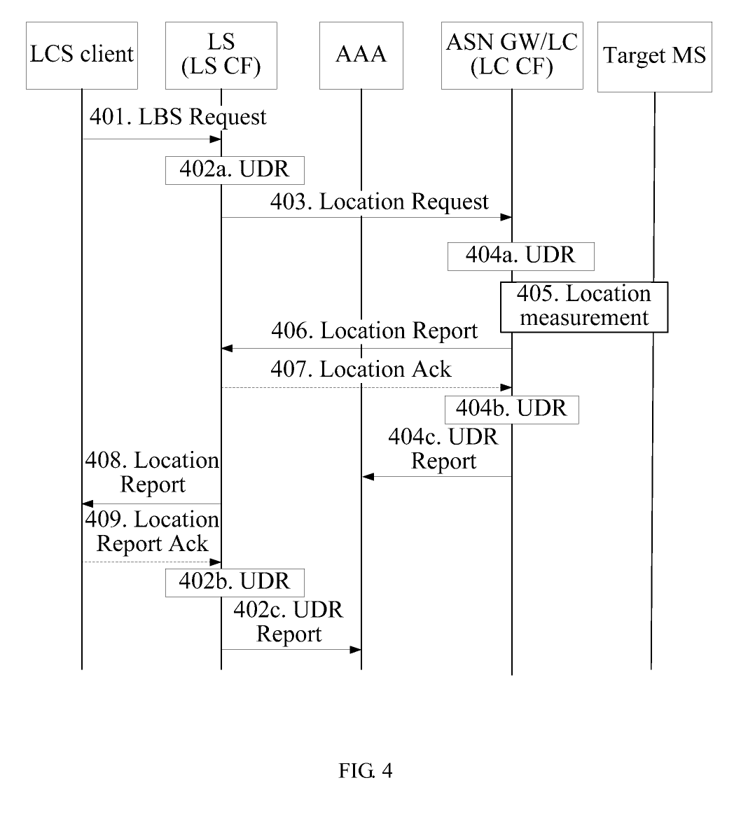

FIG. 4 shows an LBS offline accounting process in an MT-LR mode in a non-roaming scenario in the method in an embodiment of the present invention. The accounting process includes:

Step 401: The LCS client sends an LBS request to the LS. The request carries an identity of the target MS to be located, precision of the location result, response time requirement, and so on.

Step 402a: The LS processes the location request, for example, checks the user subscription information and authenticates the request privacy. The LC CF located on the LS begins to collect accounting information and create UDRs. This UDR includes but is not limited to: an identity of the location requestor, an identity of the MS to be located, location type, time of initiating the location request, time of creating the UDRs, QoS parameter (such as location precision, response time, requested QoS level) of the requested LBS, and periodical location information (such as frequency, count, or total duration), where the time of creating the UDRs and the periodical location information are optional.

Step 403: The LS sends a location request to the LC located on the ASN GW.

Step 404a: The LC CF located on the LC initiates creation of UDRs. The LC CF begins to collect accounting information and create UDRs. This UDR includes but is not limited to: an identity of the location requestor, an identity of the MS to be located, location type, time of initiating the location request, time of creating the UDRs, QoS parameter (such as location precision, response time, requested QoS level) of the requested LBS, and periodical location information (such as frequency, count, or total duration), where the time of creating the UDRs and the periodical location information are optional.

Step 405: The LC interacts with the MS to measure the data required for the location.

Step 406: The LC calculates the location result according to the location measurement data, and reports the location calculation result to the LS.

Step 407: After receiving the location result information, the LS returns a Location Ack message, indicating successful receiving of the location result. This step is omissible.

Step 402b: This step corresponds to step 404a. The LC CF located on the LC finishes collecting the location accounting information in the LC, and may create a new UDR correlated with the UDRs in step 404a, or add a new UDR entry into the UDRs generated in step 404a. The UDR includes but is not limited to: final location result data, actually applied location method, and QoS parameter of the location result.

Step 404c: The LC CF reports the created UDRs to the AAA server.

Step 408: The LS sends a location report message to the LCS client. The message carries a location result.

Step 409: The LCS client returns a location report ack message, indicating successful receiving of the location result. Because this step makes it possible for the user to escape accounting through rejection of sending the Ack message after receiving of the location result, this step is omissible.

Step 402b: This step corresponds to step 402a. The LS CF located on the LS finishes collecting the accounting information in the LS, and may create a new UDR correlated with the UDRs in step 402a, or add a new UDR entry into the UDRs generated in step 402a. The UDR includes but is not limited to: final location result data, actually applied location method, and QoS parameter of the location result.

Step 402c: The LS CF reports the created UDRs to the AAA server.

If the LCS client indicates the periodical location requirements and information in the location request, steps 405-409 need to be repeated according to the periodical location count or total duration indicated in the periodical location information. The UDRs created in the LS and LC may be sent to the accounting server uniformly after completion of all required periodical location, or sent to the accounting server at set intervals.

In the MT-LR positioning process in a roaming scenario, the LS CF on an H-LS and a V-LS and the LC CF on a V-LC need to collect the accounting information respectively and create independent accounting records. The details are similar to the counterpart part described above, and are not repeated here any further.

The positioning process initiated by a network (NI-LR mode) is generally applicable to emergent LBS. In this positioning process, the LS CF collects the accounting information and creates UDRs; and the LC CF collects the accounting information and creates UDRs. The LS and the LC send the created UDRs to the AAA server to accomplish offline LBS accounting.

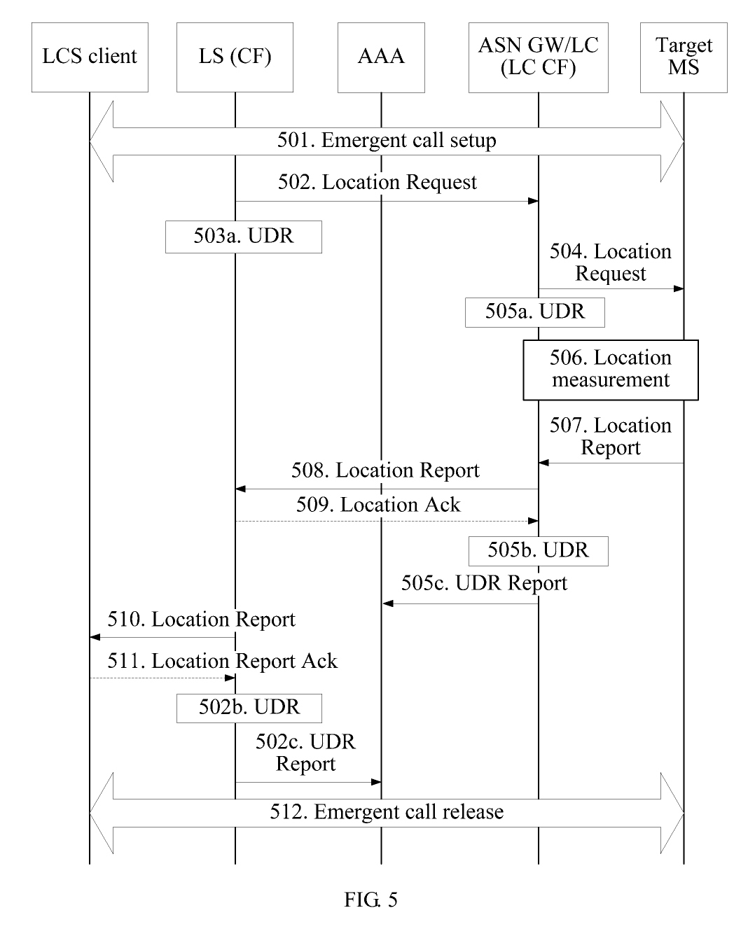

FIG. 5 shows an LBS offline accounting process in an NI-LR mode in the method in this embodiment.

The NI-LR positioning process is generally applicable to emergent LBS, and primarily, the process of creating an emergent service. In this process, the network determines the LS and the client according to the location of the located MS. After the emergent service is created, because the emergent service generally involves no process of checking privacy or authentication, the location request is sent by the LS or the network directly, and the LC initiates a positioning process in response to the location request. After completion of the positioning process, the emergent service needs to be released.

### II. Online Accounting

Unlike the location accounting process of the offline accounting, after the MS or LCS client sends a location request to the LS, the LS CF needs to apply to the PPS for a quota before the LS sends a location request to the ASN. When the PPS receives a quota request from the LS CF, the PPS needs to allocate a quota to the user according to the QoS required by the service requested by the user, LBS subscription information of the user, and account balance of the user. The quota indicates whether the LBS requested by the user is accepted. The LS proceeds with subsequent positioning operations only after the LS CF obtains the quota. If a balance of the allocated quota is left after completion of the positioning, the PPS needs to return the quota balance of the user. Likewise, if the user to be located is also an online accounting user, the LS correlated with the user to be located also needs to check the quota balance of the user before the location process. It is necessary that both the user who initiates the location and the user to be located employ the online accounting mode. Either of the users may be an offline accounting user. In this case, the offline accounting user does not need to check the balance.

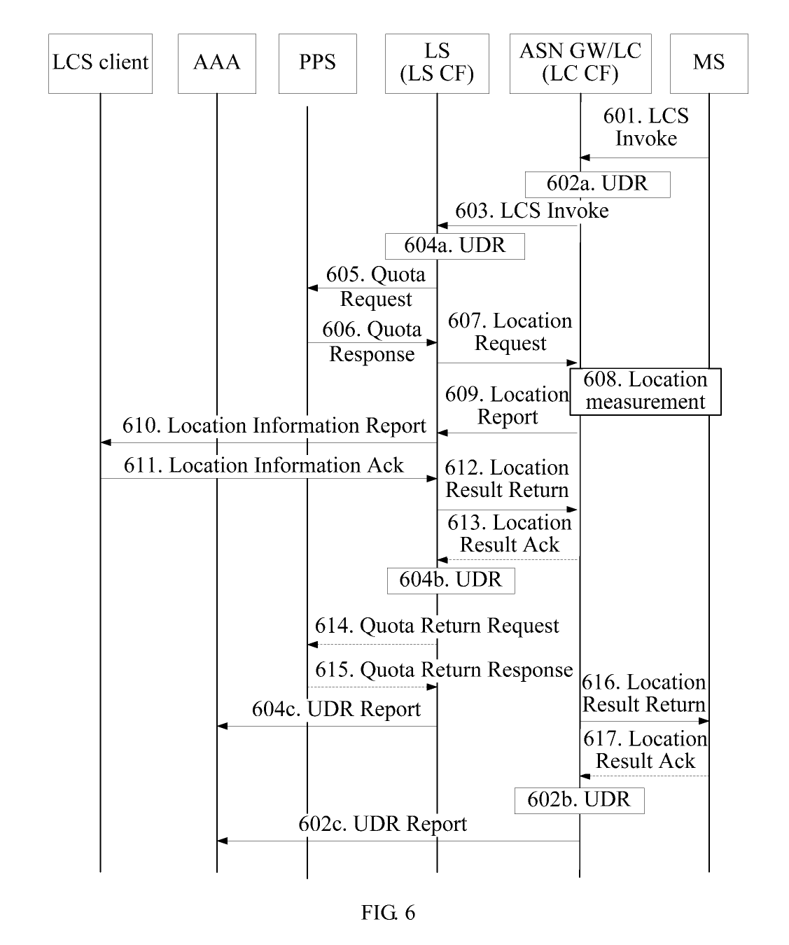

FIG. 6 shows an LBS online accounting process in an MO-LR mode in a non-roaming scenario in the method in an embodiment of the present invention.

This accounting process is almost the same as the LBS offline accounting process in the MO-LR mode in a non-roaming scenario except that the LS CF needs to apply to the PPS for a quota before the LS sends a location request to the LC on the ASN GW. The LS sends a location request only after obtaining the quota, as shown in step 603 and step 606 in FIG. 6. If the QoS level of the final location result is lower than the QoS level requested by the user, the LS CF needs to request the PPS to return the quota balance, as shown in step 614 and step 615 in FIG. 6.

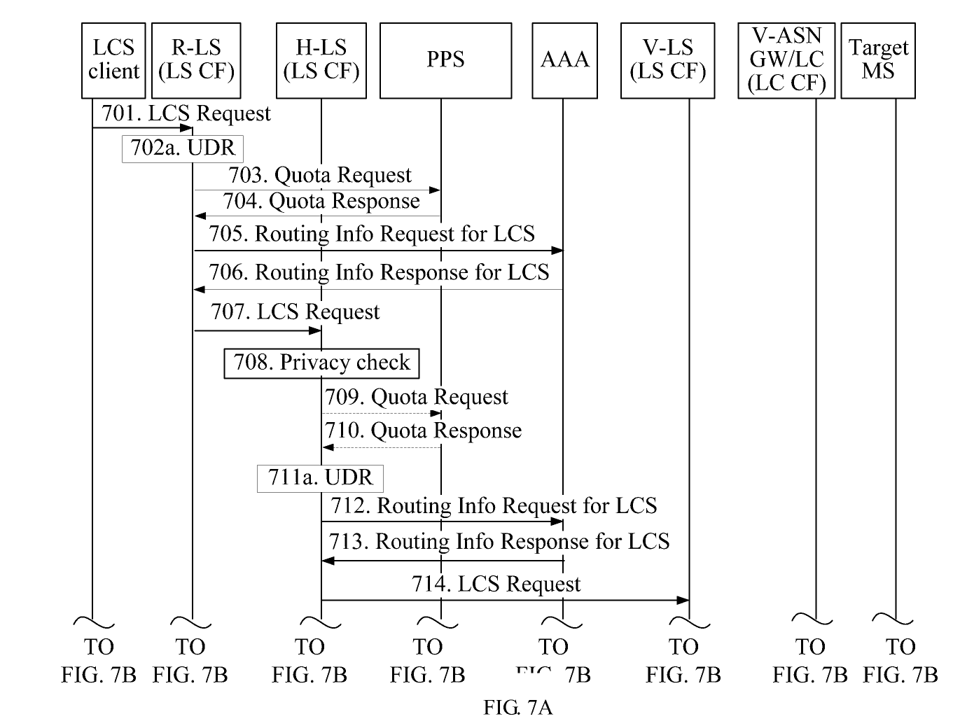

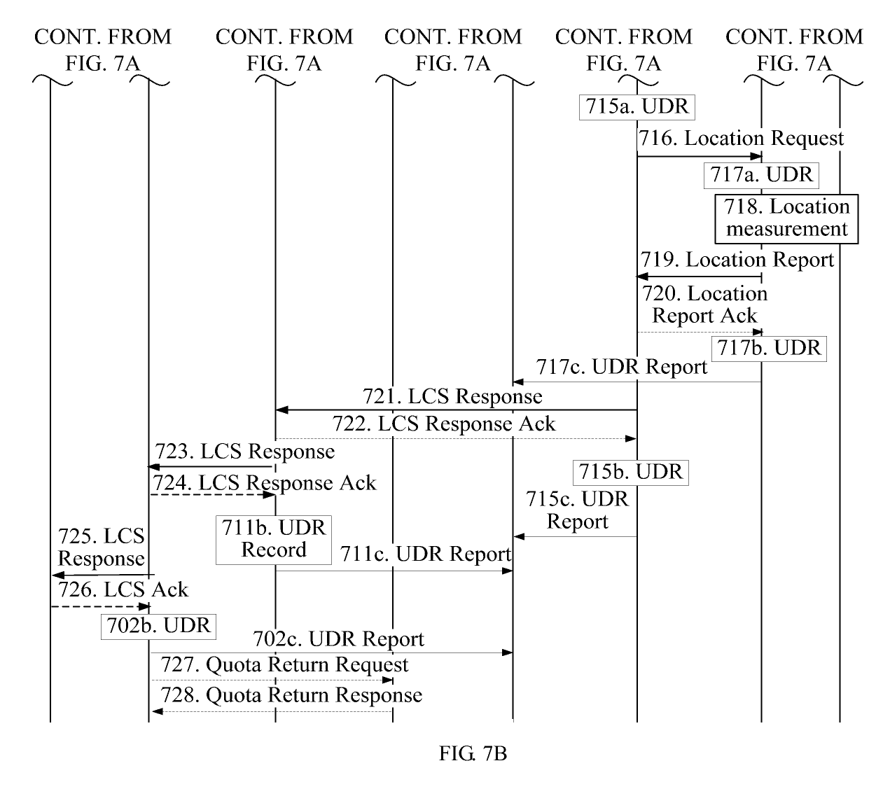

FIG. 7 shows an LBS online accounting process in an MT-LR mode in a roaming scenario in the method in an embodiment of the present invention. The accounting process includes:

Step 701: The LCS client sends an LCS service request to a Requesting Location Server (R-LS).

Step 702a: After the R-LS receives the request from the LCS client, the CF on the R-LS begins to collect accounting information and create UDRs. This UDR includes but is not limited to: an identity of the location requestor, an identity of the MS to be located, location type, time of initiating the location request, time of creating the UDRs, QoS parameter (such as location precision, response time, requested QoS level) of the requested LBS, and periodical location information (such as frequency, count, or total duration), where the time of creating the UDRs and the periodical location information are optional.

Besides, the R-LS needs to query the LS and the PPS corresponding to the LCS client. The LS may generate the corresponding accounting record. The LS CF located on the LS sends a quota request to the PPS, requesting the quota required for the location. For clarity, FIG. 9 omits the LS entity, and only shows how the LS CF on the R-LS (actually, on the LS corresponding to the LCS client) applies to the PPS related to the LCS client for the location quota. There may be more than one PPS and more than one AAA corresponding to different entities or functions for collecting the accounting information.

Step 703: The LS CF sends a quota request to the PPS related to the LCS client, requesting a location quota.

Step 704: The PPS allocates a quota to the user according to the QoS required by the service requested by the user, LBS subscription information of the user, and account balance of the user, and so on. The quota indicates whether the LBS requested by the user is accepted. The PPS returns a quota response to the R-LS.

Step 705: If the LS CF obtains the quota for the location, the R-LS sends a “Routing Info Request for LCS” message to the AAA server, with a view to querying the H-LS corresponding to the MS to be located.

Step 706: The AAA server returns a “Routing Info Response for LCS” message, which carries the address of the H-LS.

Step 707: The R-LS sends an LCS service request to the H-LS.

Step 708: The H-LS checks privacy for the LCS service request, and checks whether the MS to be located allows being located by the request sender.

Step 709: If the entity to be located is also an online accounting user, the LS CF on the H-LS sends a quota request to the corresponding PPS.

Step 710: The PPS returns a quota response to the LS CF on the H-LS. If the located user is an offline accounting user, or the user to be located does not need to be charged, this process (step 709 and step 710) is omissible.

Step 711a: The CF on the H-LS collects accounting information and creates UDRs. This UDRs includes but is not limited to: an identity of the location requestor, an identity of the MS to be located, location type, time of initiating the location request, time of creating the UDRs, QoS parameter (such as location precision, response time, requested QoS level) of the requested LBS, and periodical location information (such as frequency, count, or total duration), where the time of creating the UDRs and the periodical location information are optional.

Step 712: If the LS CF on the H-LS obtains the quota for the location, the H-LS sends a “routing info request for LCS” message to the AAA server, with a view to querying the V-LS corresponding to the MS to be located.

Step 713: The AAA server returns a “Routing Info Response for LCS” message, which carries the address of the V-LS of the target MS.

Step 714: The H-LS sends an LCS service request to the V-LS.

Step 715a: The CF on the V-LS collects accounting information and creates UDRs. This UDR includes but is not limited to: an identity of the location requestor, an identity of the MS to be located, location type, time of initiating the location request, time of creating the UDRs, QoS parameter (such as location precision, response time, requested QoS level) of the requested LBS, and periodical location information (such as frequency, count, or total duration), where the time of creating the UDRs and the periodical location information are optional.

Step 716: The V-LS sends a location request to the LC located on the V-ASN GW.

Step 717a: The LC CF initiates creation of UDRs, and begins to collect accounting information and create UDRs. This UDRs includes but is not limited to: an identity of the location requestor, an identity of the MS to be located, location type, time of initiating the location request (or time of creating the UDRs), QoS parameter (such as location precision, response time, requested QoS level) of the LBS, and periodical location information (such as frequency, count, and total duration), where the periodical location information is optional.

Step 718: The LC located on the V-ASN GW determines the location method and the data required for the location according to the QoS in the location request, interacts with the MS, and finishes data measurement required for the location.

Step 719: The LC located on the V-ASN GW returns a location report to the V-LS.

Step 720: The V-LS sends a Location Report Ack message to the LC located on the V-ASN GW, indicating successful receiving of the location result. This step is omissible.

Step 717b: This step corresponds to step 717a. The CF located on the V-LC finishes collecting the location accounting information in the LC, and may create a new UDR correlated with the UDRs in step 717a, or add a new UDR entry into the UDRs generated in step 717a. This UDR includes not only the contents carried in the UDRs in step 717a, but also the final location result data, actually applied location method, QoS parameter of the location result, and so on.

Step 717c: The V-LC CF reports the created UDRs to the AAA server.

Step 721: The V-LS returns an LCS service response to the H-LS.

Step 722: The H-LS returns an LCS Response Ack, indicating successful receiving of the location result. This step is omissible.

Step 715b: This step corresponds to step 715a. The CF located on the V-LS finishes collecting the location accounting information in the LS, and may create a new UDR correlated with the UDRs in step 715a, or add a new UDR entry into the UDRs generated in step 715a. This UDR includes not only the contents carried in the UDRs in step 715a, but also the final location result data, actually applied location method, QoS parameter of the location result, and so on.

Step 715c: The V-LS CF reports the created UDRs to the AAA server.

Step 723: The H-LS returns an LCS service response to the R-LS.

Step 724: The H-LS returns an LCS Response Ack, indicating successful receiving of the location result. This step is omissible.

Step 711b: This step corresponds to step 711a. The CF located on the H-LS finishes collecting the location accounting information in the LS, and may create a new UDR correlated with the UDRs in step 711a, or add a new UDR entry into the UDRs generated in step 711a. This UDRs include not only the contents carried in the UDRs in step 711a, but also the final location result data, actually applied location method, QoS parameter of the location result, and so on.

Step 711c: The H-LS CF reports the created UDRs to the AAA server.

Step 725: The R-LS returns an LCS service response to the LCS client.

Step 726: The LCS client returns an LCS service acknowledgement, indicating successful receiving of the location result. Because this step makes it possible for the user to escape accounting through rejection of sending the Ack message after receiving of the location result, this step is omissible.

Step 702b: This step corresponds to step 702a. The CF located on the R-LS finishes collecting the location accounting information in the LS, and may create a new UDR correlated with the UDRs in step 702a, or add a new UDR entry into the UDRss generated in step 702a. This UDRs includes not only the contents carried in the UDRs in step 702a, but also the final location result data, actually applied location method, QoS parameter of the location result, and so on.

Step 702c: The R-LS CF reports the created UDRs to the AAA server.

Step 727: If the QoS level of the final location result is lower than the QoS level requested by the user, the R-LS CF needs to request the PPS to return the quota balance.

Step 728: The PPS handles the request for returning the quota balance, and returns a quota returning response.

If the LCS client indicates the periodical location requirements and information in the location request, steps 718-726 need to be repeated according to the periodical location count or total duration indicated in the periodical location information. The UDRs generated in the V-LS, H-LS, R-LS, and V-LC may be sent to the accounting server uniformly after completion of all required periodical location, or sent to the accounting server at set intervals.

In this mode, the LS CF on the H-LS corresponding to the LCS client needs to apply to the corresponding PPS for a quota. After receiving the quota request from the LS CF, the PPS needs to allocate a quota to the user according to the QoS required for the service requested by the user, and according to the user's LBS subscription information. The LS proceeds with subsequent positioning operations only after the LS CF obtains the quota. If a balance of the allocated quota is left after completion of the positioning, the PPS needs to return the quota balance of the user. Likewise, if the target MS to be located also needs to be charged and is an online accounting user, the LS CF on the H-LS also needs to apply to the corresponding PPS for a quota. If the user to be located is an offline accounting user or does not need to be charged, this step is omissible. The PPS and the AAA in the figure correspond to different LSs and networks.

The LBS online accounting process in other location modes is similar, and is not repeated here any further.

The method under the present invention provides a solution to accounting for the LBS which is different from ordinary services (such as voice service and video service). In this method, the LS accounting is independent of the ASN accounting. The method correlates the LBS accounting with the location precision and time responsivity of the location result. The QoS levels of the location result are differentiated in light of the parameters such as location precision and time responsivity so that the quota of the location accounting is correlated with the QoS level of the location result, namely, higher QoS levels correspond to higher accounting quotas, thus improving the accounting accuracy. The method under the present invention supports accounting in different location modes, and accomplishes offline accounting and/or online accounting.

Those skilled in the art are aware that all or part of the steps of the foregoing embodiments may be implemented by hardware instructed by a program. The program may be stored in a computer-readable storage medium. The storage medium may be a Read-Only Memory (ROM)/Random Access Memory (RAM), magnetic disk, or Compact Disk (CD).

Elaborated above are a system and a method under the present invention. Although the invention is described through some exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A Location Based Service (LBS) accounting system, comprising:
a Location Server (LS) located in a Connect Service Network (CSN) and an accounting server;
wherein the LS comprises an LS Accounting Function, adapted to collect LBS-related accounting information with respect to the user who sends the location request and/or with respect to the user to be located at different time points, create Usage Data Records (UDRs) according to the accounting information, and send the UDRs to the accounting server; and
the accounting server is adapted to account for the LBS according to the received UDRs.

2. The LBS accounting system of claim 1, further comprising: a Location Controller (LC);
wherein the LC comprises an LC Accounting Function, adapted to collect LBS-related accounting information with respect to an wherein Service Network (ASN) at different time points, create UDRs according to the accounting information, and send the UDRs to the accounting server.

3. A Location Server (LS) located in Location Based Service (LBS) accounting system, wherein, the LS comprises an LS Accounting Function, adapted to collect LBS-related accounting information with respect to the user who sends the location request and/or with respect to the user to be located at different time points, create Usage Data Records (UDRs) according to the accounting information, and send the UDRs to an accounting server to account for the LBS according to the received UDRs.

4. A Location Based Service (LBS) accounting method, comprising:
collecting, by a Connect Service Network (CSN) in the LBS process, LBS-related accounting information at different time points, and creating Usage Data Records (UDRs) of a Location Server (LS) according to the accounting information; and
performing accounting for the LBS according to the UDRs of the LS.

5. The LBS accounting method of claim 4, wherein, collecting, by the CSN in the LBS process, LBS-related accounting information at different time points, and creating UDRs of the LS according to the accounting information further comprises:
collecting, by the LS in the CSN in the LBS process, LBS-related accounting information at different time points, and creating UDRs of the LS according to the accounting information.

6. The LBS accounting method of claim 5, wherein, the different time points, comprises:
the time point upon receiving by the LS the location request; and
the time point upon completing of location.

7. The LBS accounting method of claim 6, wherein, the UDR created upon receiving by the LS the location request comprises:
an identity of the location requestor, an identity of the LCS client or another entity for receiving the location result, location type, time of initiating the location request, QoS parameter of the requested LBS.

8. The LBS accounting method of claim 5, wherein, performing accounting for the LBS according to the UDRs of the LS further comprises:
sending, by the LS, the UDRs created in the LS to an AAA server or other accounting server except the AAA server; and
performing, by the AAA server or other accounting server except the AAA server, offline accounting for the LBS according to the UDRs.

9. The LBS accounting method of claim 8, wherein, sending, by the LS, the UDRs to the AAA server or other accounting server except the AAA server further comprises:
sending, by the LS, the UDRs created in the LS to the AAA server or other accounting server except the AAA server, at set intervals or uniformly after completion of all required periodical location in case of periodical location.

10. The LBS accounting method of claim 5, wherein, performing accounting for the LBS according to the UDRs of the LS further comprises:
applying, by the LS, for a quota to a Pre-Paid Server (PPS) before the LS sends a location request to the LC; and
allocating, by the PPS, a quota for the LBS; and
performing, by the PPS, accounting for the LBS according to the quota.

11. The LBS accounting method of claim 10, wherein, performing accounting for the LBS according to the UDRs of the LS further comprises:
requesting, by the LS CF, the PPS to return the balance of the allocated quota, if the Quality of Service (QoS) level of the actual location result is lower than the QoS level requested by the user.

12. The LBS accounting method of claim 4, further comprising:
differentiating, by the LS, the QoS levels of the location result, so that the quota of the location accounting is correlated with the QoS level of the location result, namely, higher QoS levels correspond to higher accounting quotas.

13. The LBS accounting method of claim 12, further comprising:
accounting, the user according to the QoS level of the actual location result, or performing no accounting, if the actual location result QoS level is lower than the QoS level requested by the user.

14. The LBS accounting method of claim 5, wherein, collecting, by the CSN in the LBS process, LBS-related accounting information at different time points, and creating UDRs of the LS according to the accounting information further comprises:
collecting, by a Home-LS(H-LS), LBS-related accounting information, and creating UDRs of the H-LS, after received location result information which send from a Visited-LS (V-LS), in a roaming scenario; and
collecting, by the H-LS, LBS-related accounting information, and creating UDRs of a home Service Network, after sending the location result to the V-LS by the H-LS.

15. The LBS accounting method of claim 4, further comprising:
collecting, by an wherein Service Network (ASN), LBS-related accounting information at different time points, and creating UDRs of the ASN according to the accounting information; and
performing accounting for the LBS according to the UDRs of the ASN.

16. The LBS accounting method of claim 15, wherein, collecting, by an Access Service Network (ASN), LBS-related accounting information at different time points, and creating UDRs of the ASN according to the accounting information further comprises:
collecting, by a Location Controller (LC) in the ASN, LBS-related accounting information at different time points, and creating UDRs of the ASN according to the accounting information.

17. The LBS accounting method of claim 16, wherein, performing accounting for the LBS according to the UDRs of the ASN further comprises:
sending, by the LC, the UDRs created in the LC to an Authentication Authorization Accounting (AAA) server; and
performing, by the AAA server, offline accounting for the LBS according to the UDRs.

18. The LBS accounting method of claim 17, wherein, sending, by the LC, the UDRs to the AAA server further comprises:
sending, by the LC, the UDRs created in the LC to the AAA server, at set intervals or uniformly after completion of all required periodical location in case of periodical location.

19. The LBS accounting method of claim 15, wherein, the UDR created after received the location request comprises:
an identity of the location requestor, an identity of the LCS client or another entity for receiving the location result, location type, time of initiating the location request, QoS parameter of the requested LBS; and
the UDR created after completion of location comprising: final location result data, actually applied location method, and QoS level of the location result.
